(19) United States
(12) Patent Application Publication
(10) Pub. No.: US 2021/0162457 A1
(43) Pub. Date: Jun. 3, 2021

(54) A DEVICE, SYSTEM AND METHOD FOR GENERATING AN ACOUSTIC-POTENTIAL FIELD OF ULTRASONIC WAVES

(71) Applicant: MYVOX AB, KlSTA (SE)

(72) Inventor: Thorbjörn EBEFORS, HUDDINGE (SE)

(21) Appl. No.: 17/046,733

(22) PCT Filed: Apr. 26, 2019
(86) PCT No.: PCT/EP2019/060812

§ 371 Date: Oct. 9, 2020

(30) Foreign Application Priority Data
Apr. 27, 2018 (SE) 1850519-8

(51) Int. Cl. B06B 1/02; H04B 11/00; G06F 3/01; B06B 1/06

(52) U.S. Cl. CPC B06B 1/0215; H04B 11/00; B06B 1/0629; G06F 3/017; G06F 3/016

(57) ABSTRACT

There is provided systems, devices and methods for system (100) for generating an acoustic-potential field of ultrasonic waves, using an array of acoustic micromachined ultrasonic transducer, MUT, elements, the array of acoustic MUT elements being comprised in one or more micromachined ultrasonic transducer, MUT; and having a controller being communicably connected to two or more of said acoustic MUT elements in said array, and being configured to control each of the two or more acoustic MUT elements to emit a modulated ultrasonic signal comprising a plurality of ultrasound waves towards one or more common focal points according to a respective phase shift of each of the two or more acoustic MUT elements, configured to cause the ultrasound waves of the modulated ultrasonic signals to be constructively combined at the common focal point(s), so as to generate an acoustic-potential field of ultrasonic waves.

### TECHNICAL FIELD

The present disclosure relates to devices, systems and methods for generating an acoustic-potential field of ultrasonic waves.

Specifically, the present disclosure relates to generating an acoustic-potential field of ultrasonic waves by devices, systems and methods implemented using micromachined ultrasonic transducer (MUT) technology.

### BACKGROUND

Various interactive haptic technologies exist, which provide a user or users with tactile or kinesthetic information or feedback, often in combination with visual information displayed on an interactive screen. The majority of existing tactile displays directly stimulate the skin. Wearable tactile displays designed to a headband, wrist band, arm band, glove, vest, glasses, or belt enable to receive haptic stimuli passively, for example as disclosed in Van Erp et al., 2005; Kim et al., 2009; Kajimoto et al., 2006; Jones et al., 2006. However, in each of these technologies, a user requires physical contact with a deformable surface, a pen, or a specially adapted glove. Such requirements reduce the usability and spontaneity with which a user may interact with a system.

While most haptic displays rely on direct contact with body parts to stimulate the receptors, some haptic actuation principles allow for the generation of non-contact haptic stimulation. Recently, there has been an increased interest in these approaches. For instance, air-jets are a comparatively simple technical solution to generate non-contact haptic feedback. See e.g. Tsalamlal et al., 2013; Kim et al., 2008. However, it is difficult to create complex haptic sensations, and the range of haptic interaction is limited due to dissipation effects. A more advanced strategy is disclosed in Gupta et al., 2013; Sodhi et al., 2013, which discloses pneumatics to create air vortices, based on which haptic feedback is generated over a distance.

Another non-contact approach for human perceivable feedback is based on focused ultrasonic waves. The key idea is to employ acoustic radiation pressure to stimulate e.g. the skin (for haptic feedback) at a distance using a two dimensional array of ultrasonic transducers. in such approaches, tactile sensations on human skin can be created by using a phased array of ultrasonic transducers to exert an acoustic radiation force on a target in mid-air. Ultrasonic waves are transmitted by the transducers, with the phase emitted by each transducer adjusted such that the waves arrive concurrently at the target point in order to maximize the acoustic radiation force exerted.

Ultrasonic haptic feedback systems create a vibrotactile sensation upon the skin of a user of the system. The focused ultrasound creates enough force at the point of intersection, hereinafter also referred to as the common focal point, to slightly displace the skin of a user. Typically, ultrasonic haptic feedback systems use ultrasound with a frequency at or above 40 kHz, which is above the threshold for receptors in the skin to feel. Therefore, a user can only detect the onset and cessation of such focused ultrasound. In order to provide a sensation that is detectable by the receptors in skin, the focused ultrasound is modulated at a lower frequency, within the detectable range of the receptors. This range is typically from 40 Hz to 500 Hz and the receptors are typically most sensitive/receptive for tactile feedback having frequencies around 200 Hz. An example of related art disclosing method and apparatus for the modulation of an acoustic field for providing haptic feedback using ultrasound is found in the patent document WO 2016/038347 A1.

However, this and other existing ultrasonic haptic technologies are still expensive, are inexact/have low resolution and are not scalable to a sufficient degree. They are further limited for use in certain applications for which the hardware devices and systems have been specifically designed to fit into. The high price, the low resolution and the need for major hardware adaptations are clear hinders to ultrasonic haptic technology being commercially available and reaching the broad market.

The present invention seeks to mitigate the above mentioned problems. Alternatively or additionally, the present invention seeks to provide an improved haptic feedback system.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In a first aspect, there is provided system for generating an acoustic-potential field of ultrasonic waves, the system comprising: an array of acoustic micromachined ultrasonic transducer, MUT, elements, the array of acoustic MUT elements being comprised in one or more micromachined ultrasonic transducer, MUT; and a controller being communicably connected to two or more of said acoustic MUT elements in said array, wherein the controller is configured to control each of the two or more acoustic MUT elements to emit a modulated ultrasonic signal comprising a plurality of ultrasound waves towards a common focal point, the plurality of ultrasound waves of the modulated ultrasonic signal each comprising a carrier wave being modulated according to a modulation signal, by: generating a respective drive signal indicative of: the modulation signal; the frequency at which the at least two acoustic MUT elements are to be controlled to emit the respective modulated ultrasonic signal, and a respective phase shift to be applied to the modulated ultrasonic signal of each of the two or more acoustic MUT elements, configured to cause the ultrasound waves of the modulated ultrasonic signals to be constructively combined at the common focal point, so as to generate an acoustic-potential field of ultrasonic waves having a focal volume around the common focal point; and sending the respective drive signal to the acoustic MUT element, wherein the two or more acoustic MUT elements of the array to which the respective drive signals are sent is each configured to: receive the respective drive signal; and emit a respective modulated ultrasonic signal in response to the respective received drive signal, thereby generating an acoustic-potential field of ultrasonic waves having a focal volume around the common focal point.

In a second a third aspect, there is provided a corresponding micromachined ultrasonic transducer (MUT), and a corresponding method, for generating an acoustic-potential field of ultrasonic waves.

According to a fourth aspect there is provided a computer program loadable into a memory communicatively connected or coupled to at least one data processor, comprising software for executing the method according to any of the embodiments presented herein when the program is run on the at least one data processor.

According to a fifth aspect there is provided processor-readable medium, having a program recorded thereon, where the program is to make at least one data processor execute the method according to of any of the embodiments presented herein when the program is loaded into the at least one data processor.

Due to the miniaturization of the transducer achieved by embodiments presented herein, and hence the miniaturization of the system in which such transducers are used, embodiments presented herein makes it possible to use actuator microsystems, e.g. enabling in air or non-contact/contactless generation of an ultrasonic acoustic-potential field in many different applications. The miniaturization further allows implementation in devices such as mobile smart phones, tablets, smart televisions, infotainment systems in vehicles etc. Within a vehicle cock-pit or interior non destructive HMI is beneficial from a safety perspective. For example, embodiments presented herein enable a driver assistant system wherein smart HMI on hands, fingers, shoulder or ear can guide and give tactile and/or audio feedback to the driver without taking away attention from the road. Such a system may also be adapted to check the health condition of the driver, by measuring pulse, stress level, etc. Other applications may include, but are not limited to, human machine interfaces (HMIs), such as interactive interface presentation devices, vehicle interior monitoring or control, safety applications, robotics, gaming, virtual reality (VR), augmented reality (AR), immersive (virtual) reality (IR), etc, and machine machine interfaces (MMI) for example for assembly and/or manufacturing of microelectronic.

One non-limiting example application where in air human perceivable feedback is very advantageous is in hospital and healthcare settings, or in other public settings, where reduction of touch based human machine interface (HMI) interaction can greatly reduce the risk of contamination via surfaces since there is no need for touching an actual surface or use a glove or other device. Also check-in machine at airports, railway stations, hospitals and the like would for the same reasons benefit from contactless interaction, instead of todays used keyboards or touchscreens.

Furthermore, all embodiments presented herein provide the advantages of being very cost effective compared to currently existing non-miniaturized in air human perceivable solutions, due to the use of MUT technology for transducers and systems.

Yet another advantage is that a higher resolution and precision is enabled compared to non-miniaturized solutions, since the MUT based solutions presented herein enables acoustic MUT element arrays of more than 400 channels, for example but not limited to 24×24, 36×36, 48×48, 64×64, 96×96 or 128×72 sensors, which cannot be achieved cost effectively or with the same small component or system size using the technology of the existing discrete ultrasonic transducers and systems for providing generation of an ultrasonic acoustic-potential field without the end product being very expensive and therefore not an options to develop, or for consumers to buy. The existing technologies are thereby not scalable to nearly the same degree as the MUT based embodiments presented herein.

Furthermore, embodiments with 96×96 or 128×72 MUT elements provide a MUT having almost 10 000 channels. This high resolution cannot be achieve using non miniaturized existing technology. Such a large resolution of the array in turn enables using a greater number of acoustic MUT elements for emitting a respective modulated ultrasonic signal towards each common focal point compared to the existing technologies, which gives improved focus capabilities and a higher maximum energy or acoustic pressure at the focal volume, and/or emitting modulated ultrasonic signals towards an increased number of common focal points, thereby enabling for example more realistic tactile stimulation feedback or auditory feedback, or simultaneous trapping and possibly acoustic levitation and manipulation of numerous objects using a single system. In an “acoustic tweezers” system, as described herein, e.g., it may further be advantageous to use more than two, for example three, four, or possibly more, acoustic lobes for levitation and/or manipulation of an object captured between the acoustic lobes. Thereby, wobbling of the captured object may be avoided or at least significantly reduced, and precision hence increased, especially in cases where the focal volume may be larger than desired where a larger number of acoustic lobes may be used for compensating for this.

Yet a further advantage is that devices, systems and methods according to embodiments herein using micromachined components can operate at very low power levels. Further, transducers, systems and methods of the present invention are ideal for always-on applications.

Furthermore, various embodiments described herein can provide increased robustness. For instance, transducers, systems and methods using ultrasound may not be or affected, or may be minimally affected, by light, temperature, characteristics of objects/surfaces, and the like.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

The invention is now to be explained more closely by means of preferred embodiments, which are disclosed as examples, and with reference to the attached drawings.

FIGS. 1a, 1b and 1c show schematic overviews of a system according to one or more embodiments;

FIG. 2 shows a schematic overview of a system according to one or more embodiments;

FIG. 3 shows a schematic overview of a micromachined ultrasonic transducer (MUT) according to one or more embodiments;

FIGS. 4 and 5 illustrate an array with acoustic MUT elements emitting ultrasonic waves, according to one or more embodiments;

FIG. 6 illustrates an array with acoustic MUT elements emitting modulated ultrasonic signals towards a common focal point, according to one or more embodiments;

FIG. 7 illustrates a system with acoustic MUT elements emitting modulated ultrasonic signals towards two different common focal points, according to one or more embodiments;

FIG. 8 illustrates a system with acoustic MUT elements emitting modulated ultrasonic signals towards two different common focal points and an exemplary HMI application, according to one or more embodiments;

FIG. 9 illustrates a system with acoustic MUT elements emitting modulated ultrasonic signals towards two different common focal points and an exemplary application of acoustic trapping, according to one or more embodiments;

FIG. 10 is a flow chart of a method according to one or more embodiments;

FIG. 11 shows a schematic overview of generation of a modulated ultrasonic signal;

FIG. 12 shows a schematic overview of a system with MUTs located on a non-flat surface, according to one or more embodiments;

FIGS. 13a and 13b show schematic overviews of a system according for acoustic levitation and manipulation with standing waves according to one or more embodiments;

### DETAILED DESCRIPTION

### Introduction

The present disclosure describes a device, system and method for generating an acoustic-potential field of ultrasonic waves, using micromachined ultrasonic transducer (MUT) technology.

While a brief overview is provided, certain aspects of the subject disclosure are described or depicted herein for the purposes of illustration and not limitation. Thus, variations of the disclosed embodiments as suggested by the disclosed apparatuses, systems and methodologies are intended to be encompassed within the scope of the subject matter disclosed herein.

As a non-limiting example, the MUTs used in embodiments presented herein may be microelectromechanical systems (MEMS) devices, preferably Silicon based MEMS devices.

A common focal point in the context of the present disclosure may be defined as having a set of spatial coordinates according to any suitable coordinate system, e.g. as having x, y and z coordinates, spherical coordinates or Euclidian coordinates.

System Architecture

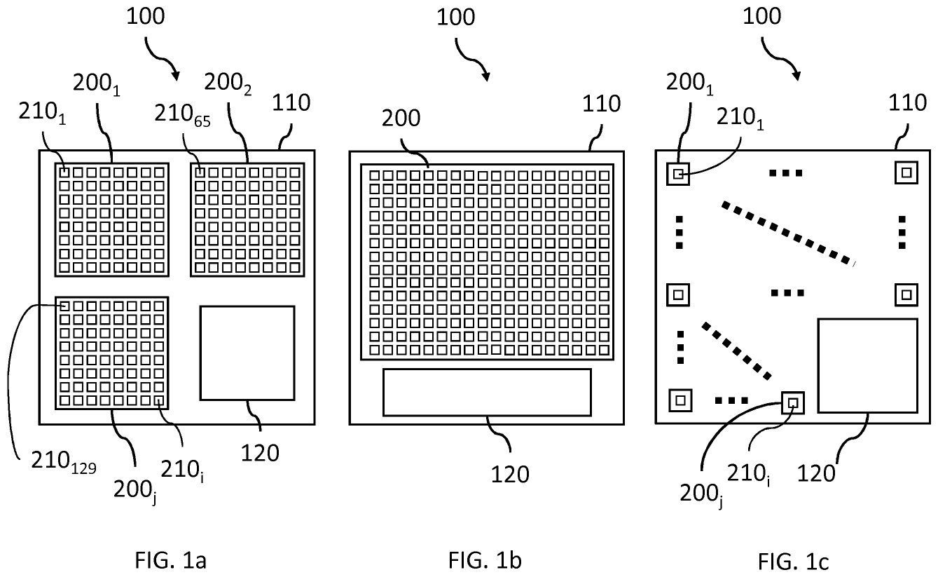

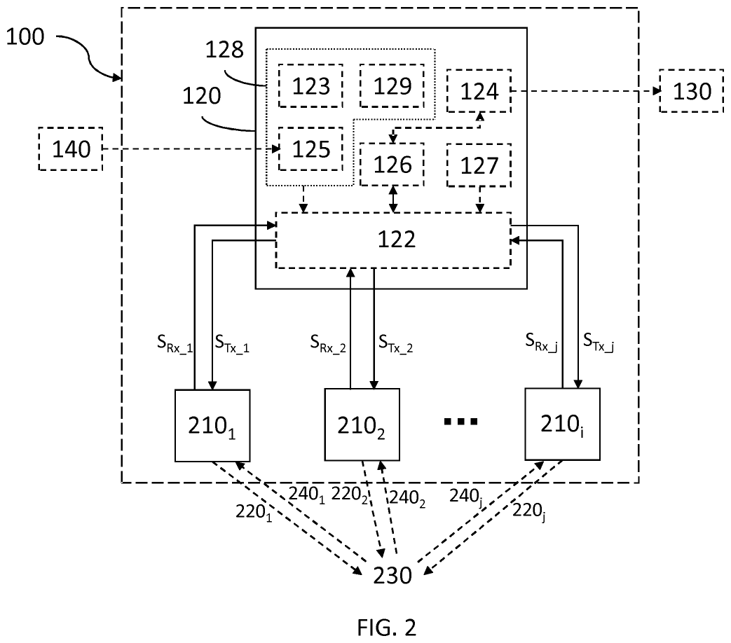

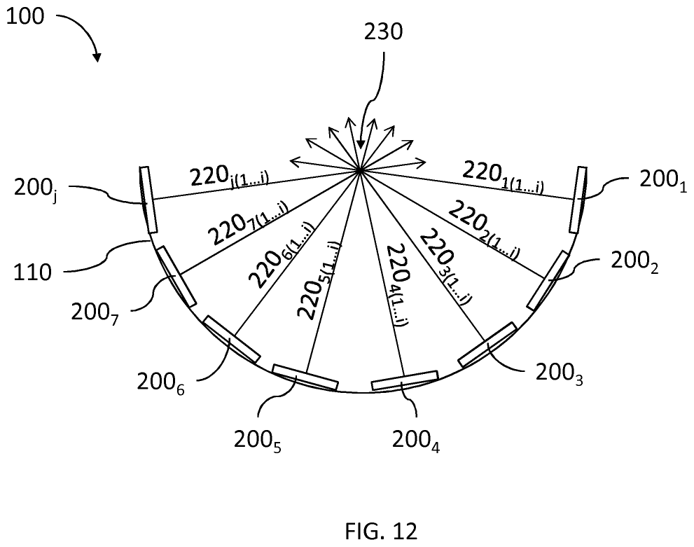

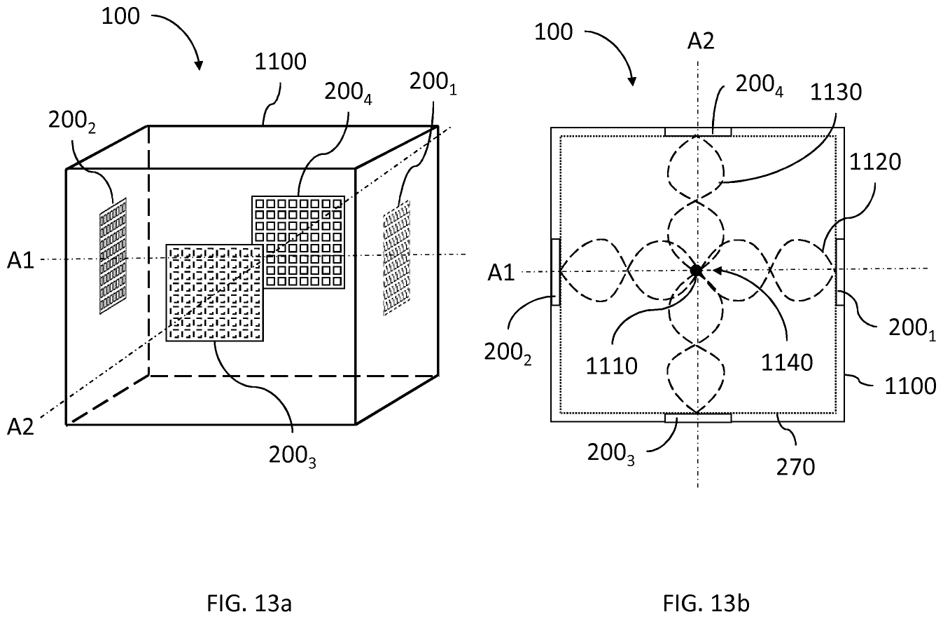

Turning now to FIG. 1a to 1c and 2, there is shown a system 100 for generating an acoustic-potential field 270 of ultrasonic waves according to embodiments presented herein. The system 100 comprises an array of acoustic micromachined ultrasonic transducer, MUT, elements 210_{1 . . . i}. The array of acoustic MUT elements 210_{1 . . . i} may be a two dimensional array comprised on a planar surface, e.g. as shown in FIG. 1, or an array comprised on a curved surface, e.g. as shown in the non-limiting example of FIG. 12, or an array comprised on several connected planar or curved surfaces attached to each other at non-zero angles, e.g. as shown in the non-limiting example of FIG. 13a.

As illustrated in FIGS. 1a to 1c, the acoustic MUT elements 210_{1 . . . i} in the array may part of, or comprised in, one or more micromachined ultrasonic transducers (MUT) 200. In FIG. 1a, an embodiment is shown wherein the array of acoustic MUT elements 210_{1 . . . i} is built up from a number of MUTs 200_{1 . . . j} (in the figure exemplary illustrated as j=3) each comprising numerous acoustic MUT elements 210. In FIG. 1b, another embodiment is shown wherein the array of acoustic MUT elements 210_{1 . . . i} is built up by a single MUT comprising numerous acoustic MUT elements 210. In FIG. 1c, yet another embodiment is shown wherein the array of acoustic MUT elements 210_{1 . . . i} is built up from a number of MUTs 200_{1 . . . j} each comprising a single acoustic MUT element.

The system 100 further comprises a controller 120 being communicably connected to two or more of the acoustic MUT elements 210 in the array. The controller 120 is configured to control each of the two or more acoustic MUT elements 210 to emit a respective modulated ultrasonic signal 220, comprising a plurality of ultrasonic waves, towards a common focal point 230. These two or more acoustic MUT elements 210 that are emit a respective modulated ultrasonic signal 220 may be referred to as actuating acoustic MUT elements 210. The plurality of ultrasonic waves of the modulated ultrasonic signal 220 each comprises a carrier wave 221 being modulated according to a modulation signal 222.

Depending on the application, the modulation may be generated based on amplitude modulation (AM), e.g. DSBAM, dual side band suppressed Carrie modulation, frequency modulation, pulse width modulation, Square-root Amplitude modulation (SRAM), Single SideBand (SSB) modulation, dual Single SideBand (SSB) modulation, Modified Amplitude Modulation (MAM), and/or any other suitable modulation technique known in the art. For embodiments described herein as relating to contactlessly capturing/trapping, levitating and/or manipulating and object, modulation may comprise modulating with a factor 1, wherein the modulation signal 222 comprises no information or information that the carrier wave 221 is to be modulated with a factor 1.

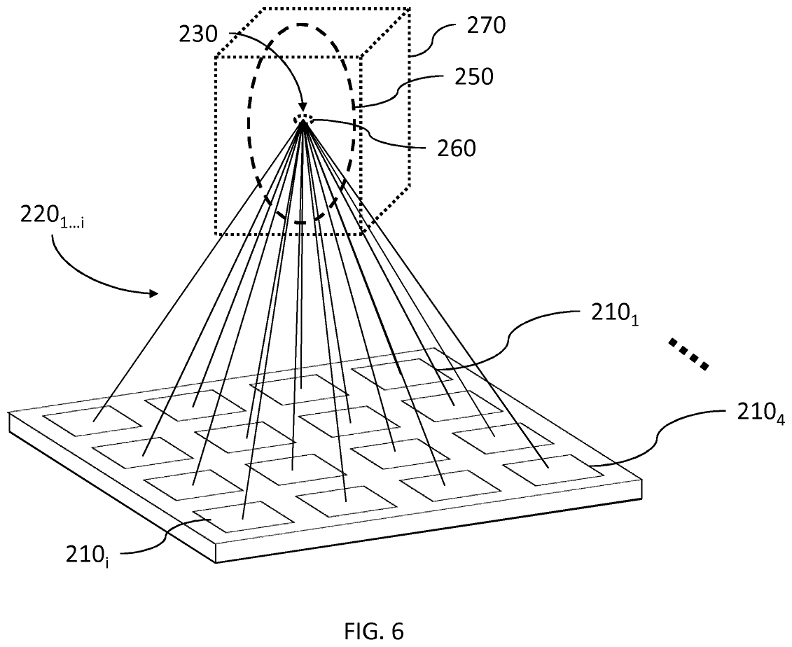

An illustration of an array of acoustic MUT elements 210 emitting such modulated ultrasonic signals 220 at a common focal point 230 is shown in FIG. 6.

Turning again to the schematic system 100 of FIG. 2, the controller 120 is configured to control each of the two or more acoustic MUT elements 210 to emit a modulated ultrasonic signal 220 by, for each of the two or more acoustic MUT elements 210, generating a respective drive signal S_{Tx} indicative of:
the modulation signal 222,
the frequency of the carrier wave 221, and
a respective phase shift to be applied to the modulated ultrasonic signal 220 of each of the two or more acoustic MUT elements 210, configured to cause the ultrasonic waves of the modulated ultrasonic signals 220 to be constructively combined at the common focal point 230.

The drive signal may also comprise voltages and/or currents needed to enable the two or more acoustic MUT elements to operate. The controller is further configured to, still for each of the acoustic MUT elements 210, send the respective S_{Tx} to the acoustic MUT element 210. The two or more acoustic MUT elements 210 of the array, to which the respective drive signals S_{Tx} are sent, are in turn each configured to receive the respective drive signal S_{Tx} and emit a respective modulated ultrasonic signal 220 in response to the respective received drive signal S_{Tx}.

As illustrated in FIG. 6, thereby an acoustic-potential field 270 of ultrasonic waves is generated around the common focal point 230, wherein the acoustic-potential field 270 has a focal volume 260 with a certain extension, or spot size, directly around the common focal point 230. The focal volume 260 may be disc shaped, but its shape depends on the emission directions of the modulated ultrasonic signal 220. The focal volume, or spot size, should be kept as small as possible to obtain the best possible focus of the emitted acoustic energy. By using MUT technology, preferably MEMS technology, according to embodiments presented herein, enabling the use of higher frequencies/shorter wavelengths, the spot size can be reduced considerably compared to existing non-miniaturized solution. In one or more embodiments, the controller 120 may be configured to control the two or more acoustic MUT elements 210 to emit the respective modulated ultrasonic signal 220 with an electro-mechanical resonance frequency of the MUT element 210 generating the modulated ultrasonic signal 220 in the range of 20 kHz to 10 MHz, preferably in the range of 100 kHz to 500 kHz, more preferably in the range of 120 kHz to 350 kHz. This advantageously provides a small maximum cross-section diameter of the focal volume 260, or in other words a small spot size and a large output effect within the focal volume 260. Expressed in another manner, the controller 120 may be configured to control the two or more acoustic MUT elements 210 to emit the respective modulated ultrasonic signal 220 with a carrier wave 221 having a frequency configured to generate a focal volume 260 with a maximum cross-section diameter, or spot size, of less than 5 mm, preferably less than 3 mm, which is obtained at approximately 120 kHz electro-mechanical resonance frequency of the MUT element 210 generating the modulated ultrasonic signal 220, or higher, more preferably less than 1 mm which is obtained at approximately 340 kHz electro-mechanical resonance frequency of the MUT element 210 generating the modulated ultrasonic signal 220, or higher. Depending on the application, different electro-mechanical resonance frequencies are desirable. For example, for haptic stimulation feedback at a decimeter range (including 5 cm to 50 cm) distance from the system 100, the an electro-mechanical resonance frequency should be controlled to around 200 kHz for the best possible user experience of the feedback. In another example, for auditory stimulation feedback at a meter range (including 50 cm to 200 cm) distance from the system 100, the an electro-mechanical resonance frequency should be controlled to around 100 kHz for the best possible user experience of the feedback. In yet another example, for acoustic trapping, enabling non-contact levitation and/or manipulation, of objects of less than a millimeter up to a centimeter in diameter or maximum cross section width, the electro-mechanical resonance frequency should be controlled to above 500 kHz to obtain a sufficiently small focal volume 260 or node 1140 to capture/trap the object and enable the acoustic levitation and/or manipulation.

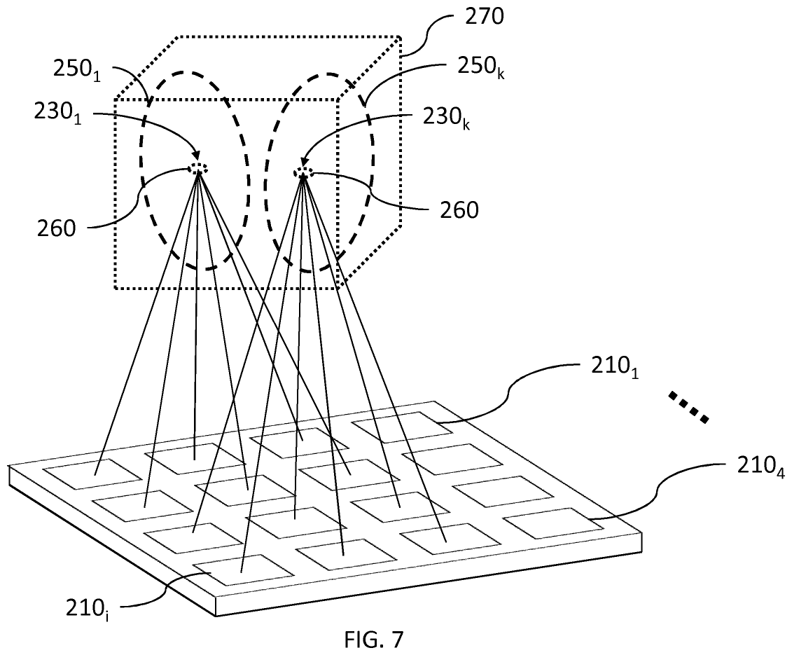

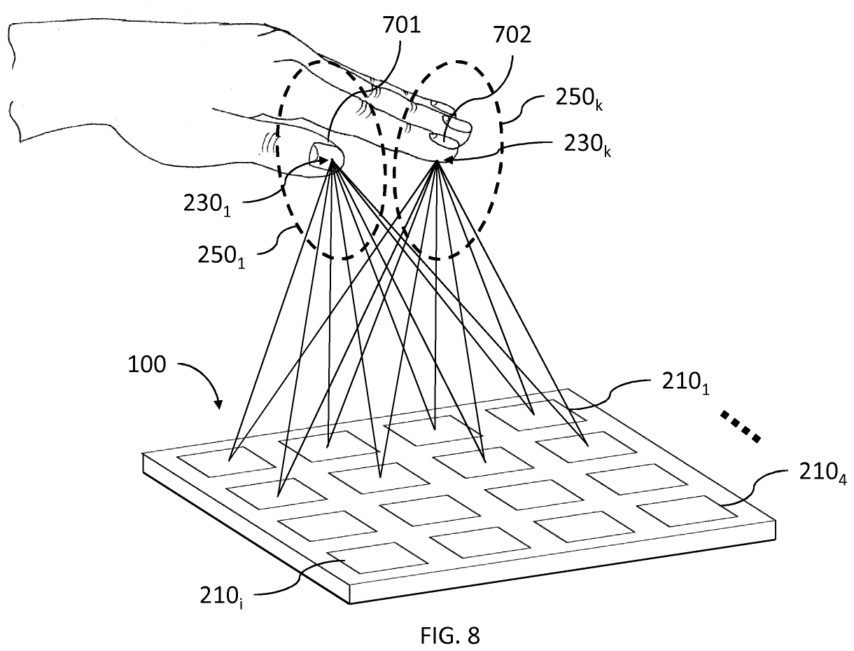

Of course, the controller 120 may be configured to control the two or more acoustic MUT elements 210 of the array to emit respective modulated ultrasonic signals 220 towards multiple common focal points 230_{1 . . . k}, wherein k represents the maximum number of common focal points that a particular system 100 is capable of generating during operation. In FIGS. 7 and 8, emission of modulated ultrasonic signals 220 towards two common focal points 230 is shown, for ease of illustration. The emitting acoustic MUT elements may be referred to as actuating acoustic MUT elements.

In the example of FIG. 7, emission of modulated ultrasonic signals 220 towards two common focal points is achieved by a first group of two or more acoustic MUT elements 210 in the array (in this example number 210₅, 210₆, 210₉, 210₁₀, 210₁₃ and 210₁₄) emits a respective modulated ultrasonic signal 220 (here 220₅, 220₆, 220₉, 220₁₀, 220₁₃ and 220₁₄) at a first common focal point 230₁, and a second group of two or more acoustic MUT elements 210 in the array (in this example number 210₇, 210₈, 210₁₁, 210₁₂, 210₁₅ and 210₁₆) emits a respective modulated ultrasonic signal 220 (here 220₇, 220₈, 220₁₁, 220₁₂, 220₁₅ and 220₁₆) at a second common focal point 230₂.

In the example of FIG. 8, each of the actuating acoustic MUT elements 210 in the array (in this example number 210₁, 210₂, 210₅, 210₆, 210₉, 210₁₀, 210₁₃ and 210₁₄) emits a respective modulated ultrasonic signal 220 (here 220₁, 220₂, 220₅, 220₆, 220₉, 220₁₀, 220₁₃ and 220₁₄) at both a first common focal point 230₁ and a second common focal point 230₂. This may be achieved by each of the actuating acoustic MUT elements 210 emitting it's respective modulated ultrasonic signal 220 towards the a first common focal point 230₁, using a first beamforming or modulation setting, and at a second common focal point 230₂, using a first beamforming or modulation setting, at alternating time instances. This way, the modulated ultrasonic signal 220 of each actuating acoustic MUT elements 210 will reach both the first common focal point 230₁ and the second common focal point 230₂ with maximum energy. If there is a large number of common focus points, the time between emissions to each common focal point 230 will of course be longer. Alternatively, emission towards the two (or more) common focal point 230₁, 230₂ may be achieved by each of the actuating acoustic MUT elements 210 emitting it's respective modulated ultrasonic signal 220 towards the common focal points 230 simultaneously. Thereby there is no time delay, but the energy emitted towards each common focal point 230 is instead reduced due to the spatial division.

The acoustic-potential field 270 of ultrasonic waves may be used for, and the system hence be adapted for providing, non-contact or in-air human perceivable feedback to a user in a human machine interface (HMI). As some non-limiting examples, the system 100 may be adapted for providing non-contact human perceivable feedback to a user in a cockpit of a motorized vehicle, wherein the vehicle may be a car, a truck, a bus, an airplane or a train, and the user may correspondingly be a driver, pilot, co-driver, co-pilot or passenger of the motorized vehicle. In another non-limiting example, the system 100 may be adapted for providing non-contact human perceivable feedback to a user in a robotics application. In some embodiments, the controller 120 may configured to control each of the two or more acoustic MUT elements 210 to emit the modulated ultrasonic signal 220 at a frequency within a frequency spectrum configured to produce a human perceivable sensory stimuli, so as to produce human perceivable sensory feedback if sensed by a human sensory organ at the common focal point 230. In some of these embodiments, the controller 120 may be configured to control each of the two or more acoustic MUT elements 210 to emit the modulated ultrasonic signal 220 at a frequency within a frequency spectrum configured to produce a human perceivable tactile stimuli, so as to produce human perceivable tactile feedback if sensed by a human tactile sensory organ at the common focal point 230. This means that a human will feel the ultrasonic energy focused at the common focal point 230 on the as a tactile stimulation of the skin. An example is shown in FIG. 8, wherein the system 100 is used in an HMI to enable a user to receive tactile feedback stimulation on a thumb 701 at a first common focal point 230₁ and tactile feedback stimulation on an index finger 702 at a second common focal point 230₂. By adding further common focus points 230 and/or swiftly switching between numerous common focus points, enabled thanks to the high frequency of the respective carrier wave 221, according to embodiments herein, a great number of feedback points, or even the sensory experience of touching a surface or three-dimensional volume, in air, may be achieved. To enable the sensory experience of touching a surface or three-dimensional volume, in air, multiple common focus points 230 are needed. In other embodiments, or in combination with enabling tactile stimulation feedback, the controller 120 may be configured to control two or more acoustic MUT elements 210 to emit the modulation signal 222 at a frequency within a frequency spectrum configured to produce a human perceivable auditory stimuli when the ultrasonic waves of the modulated ultrasonic signals 220 converge at the common focal point 230. Of course, tactile stimulation feedback and auditory stimulation feedback may be provided at different common focal points 230, wherein the auditory stimulation is preferably directed at a common focal point close to an ear drum of the user, and the tactile stimulation feedback at a point where it can be felt on the skin of the user.

In some embodiments, the at least one MUT 200 and the controller 120, as well as any optional component that may additionally be comprised in the system, may be fixedly arranged on a substrate 110. In a preferred embodiment, the at least one MUT 200 and the controller 120, as well as any optional component that may additionally be comprised in the system, may alternatively be embedded in a substrate 110. This is advantageous since the resulting transducer will have a substantially flat surface without protrusions, possibly have a smaller height than a transducer where the components are arranged on the substrate, and the components are better secured to the substrate. In one or more embodiment, the at least one MUT 200 and the controller 120 may have been embedded in the substrate 110 and electrically connected using a fan out wafer level processing (FOWLP) technique, or a fan out panel level processing (FOPLP) technique, or the like, whereby the electrical connections between the system components are less prone to breaking, since they do not have any protruding parts. The substrate 110 for embedding the components may consist substantially of an epoxy material. In other embodiments, the substrate may consist substantially of silicon.

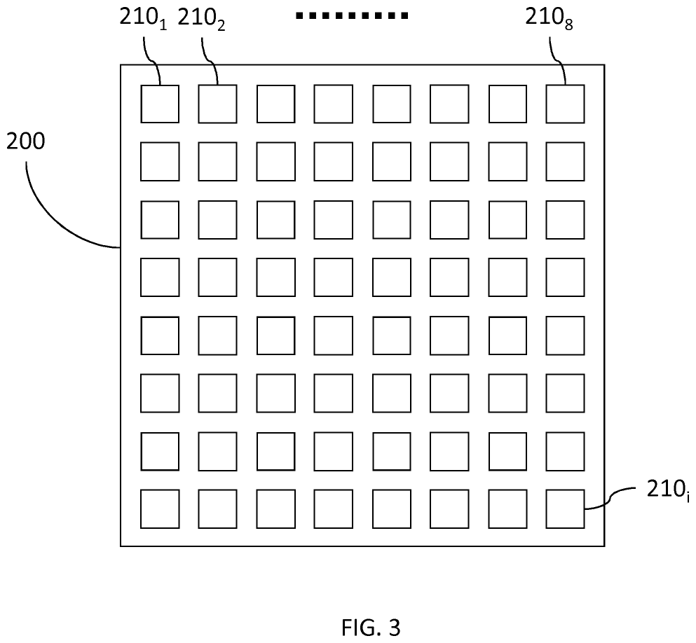

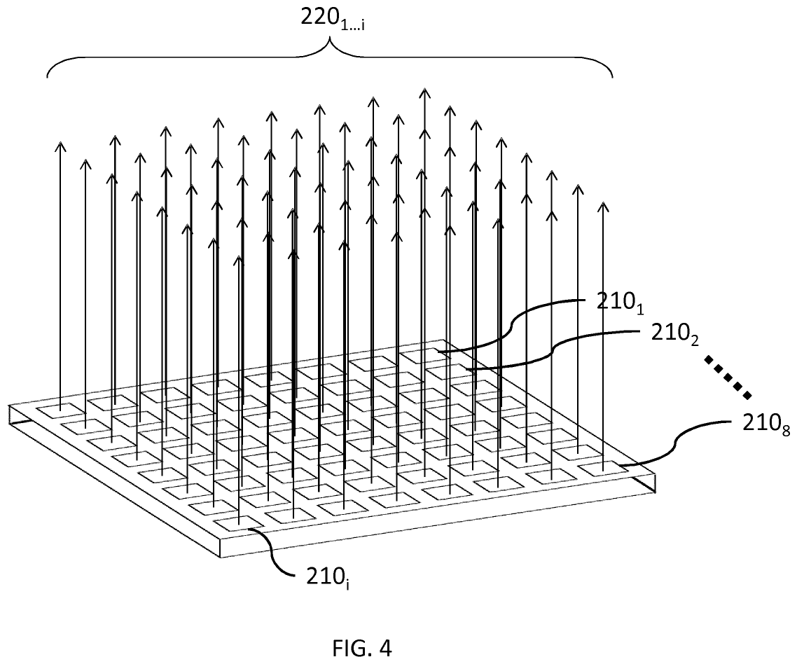

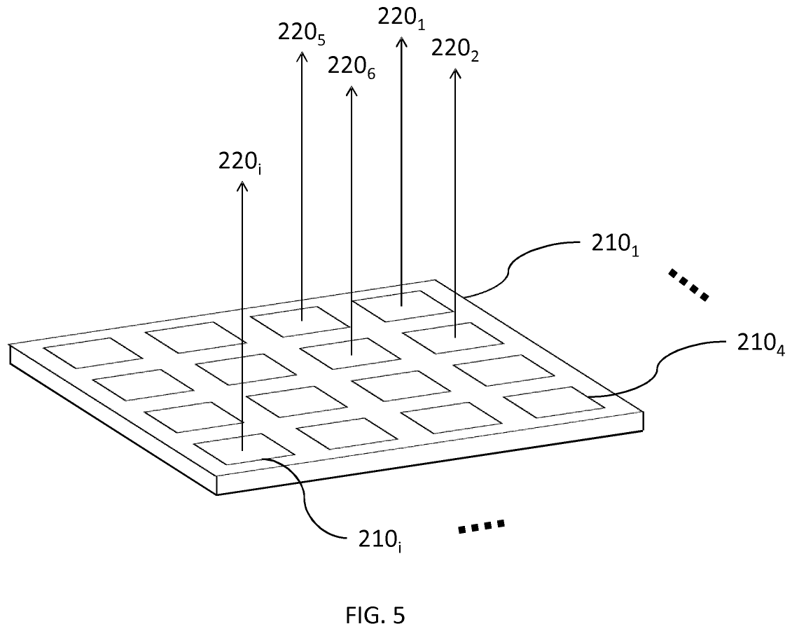

The substrate 110 and/or the resulting system 100 may be flat, as illustrated in FIGS. 3 to 9. In other embodiments, the substrate 110 and/or the resulting system 100 may have a non-flat shape that enables provision of a common focal point for the emitted ultrasonic signals 220 by mechanical beam-forming, i.e. due to the placements and direction of the MUTs in relation to each other, instead of electrical beam-forming, for example beam-forming achieved according to embodiments described herein using phase shift or time shift of emitted ultrasonic signals. An example of a non-flat surface or system, in this case in the shape of a dome, is shown in FIG. 12. Other non-limiting examples are to provide a bendable substrate 110, or to provide a system 100 comprised of a number of flat surfaces combined at non-zero angles in relation to each other, for example but not limited to the shape of a box, as exemplified in FIG. 13a. The non-limiting example of a dome or a whole or part of a substantially spherical enclosure is advantageous because the ultrasonic pressure at the common focus point or human perceivable feedback point is the same from all emitting acoustic MUT elements 210, since the distance is the same, within an allowable tolerance, between the one or more common focus point 230 and each of the acoustic MUT elements 210.

In combination with any of the embodiments presented herein for non-flat surface 110 or system 100, electrical and mechanical beam-forming may be used in combination to achieve a greater number of common focus points 230.

In some embodiments, the non-contact ultrasonic feedback system 100 is further configured to recognize a gesture using ultrasonic gesture recognition, and generate the acoustic-potential field 270 of ultrasonic waves in response the recognized gesture. The controller 120 may in these embodiments be configured to receive a detection signal S_{Rx} from at least one acoustic MUT element 210 of at least one in said two dimensional array; identify a gesture based on the received detection signal or signals S_{Rx}; and generate the respective drive signal S_{Tx} in response to identifying a gesture.

Turning again to FIG. 2, details of the controller 120 according to one or more embodiments are shown. As shown in the figure, the controller 120 may comprise an analogue frontend block 122 configured to constitute a first interface towards the acoustic MUT elements 210_{1 . . . i}; an internal digital processing block 126 comprising digital processing circuitry being communicably connected to the analogue frontend block 122; a second interface 124 towards an external processor 130, configured to communicate information and signals between the external processor 130 and the analogue frontend 122; a modulation block 127 configured to generate a modulation signal 222 and communicate the modulation signal 222 to the analogue frontend block 122. The modulation block 127 may be integrated in the digital processing block 126, or be implemented as a separate block or component. The controller 120 may further comprise a support block 128 communicably connected to the analogue frontend block 122, the support block being configured to generate oscillations at a frequency corresponding to the frequency of at which the at least two acoustic MUT elements 210 are to be controlled to emit the respective modulated ultrasonic signal 220, and voltages or currents needed to enable the at least two acoustic MUT elements 210 to operate. In some embodiments, the support block 128 comprises an oscillator 129 configured to be controlled to oscillate at different frequencies, for example in the form of a clock generator; and a power block in the form of a battery 123, or a power management unit 125 communicably and electrically connected to a power source 140, wherein the power source 140 is external to the system 100 or integrated in the system 100. The battery 123 or power source 140, via the power management unit 125, is then configured to provide power to the at least two acoustic MUT elements 210.

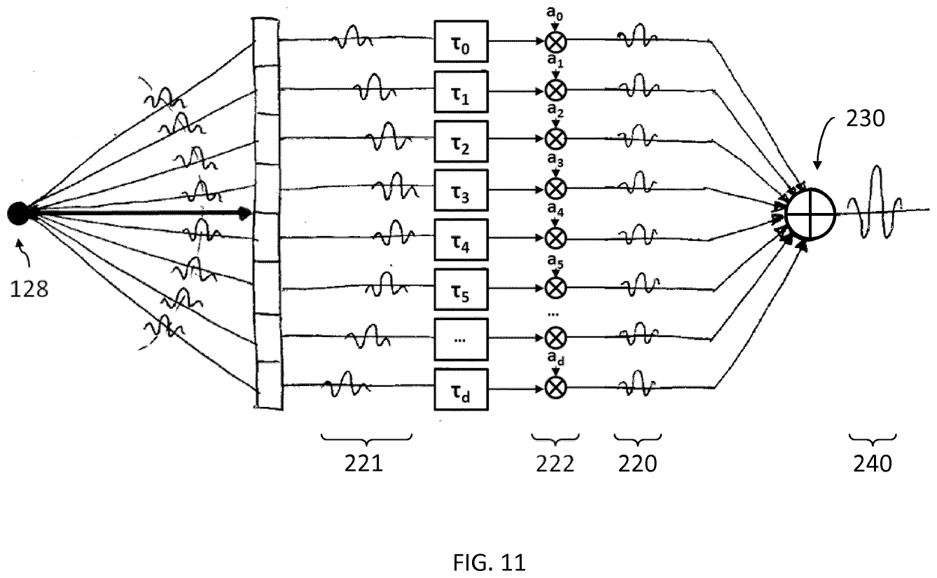

In FIG. 11, modulation of carrier waves 221, which have been generated according to a frequency provided by the support block 128, is illustrated. When applicable, the controller 120 may be configured to control the acoustic MUT elements 210 in an array of acoustic MUT elements to emit their respective carrier waves 221 also at different amplitudes. In these cases, the applicable amplitudes are also provided by the support block 128. The carrier waves 221 are phase shifted using the time delays T₀ to T_{d}. Thereafter, a modulation signal 222 according to any of the embodiments presented herein is applied to each respective carrier wave to obtain the modulated ultrasonic signals 220. At one or more common focal points 230, the modulated ultrasonic signals 220 are constructively combined. This is illustrated in FIG. 11 by the higher amplitude combined signal 240. In one or more embodiments, the analogue frontend block 122 may be configured to generate the drive signal S_{Tx} based on the modulation signal 222 received from the modulation block 127, and the frequency at which the at least two acoustic MUT elements 210 are to be controlled to emit the respective modulated ultrasonic signal 220, and voltages and/or currents, received from the support block 128. The analogue frontend block 122 may be implemented in an analogue circuit, more preferably in an application specific integrated circuit, ASIC. The internal digital processing block 126 may be implemented in a field-programmable gate array (FPGA) or a digital signal processor (DSP). In some embodiments, the analogue frontend block 122 and the digital processing block 126 are implemented in a single mixed signal analogue/digital ASIC.

In different embodiments, the blocks of the controller 120 may be implemented in the form of several discrete parallel connected electrical components, or with some or all blocks implemented as a single component. By combining several blocks in one component, for example in an embodiment wherein only one or two ASICS comprise all of the blocks of the controller 120, the total size of the system 100 will be no more than one or a couple of centimeters in length and width respectively, which enables use in devices such as displays, mobile phones, smart television apparatuses, etc. At the same time, the number of available channels is substantially higher than what is enabled by existing non-miniaturized ultrasonic technologies.

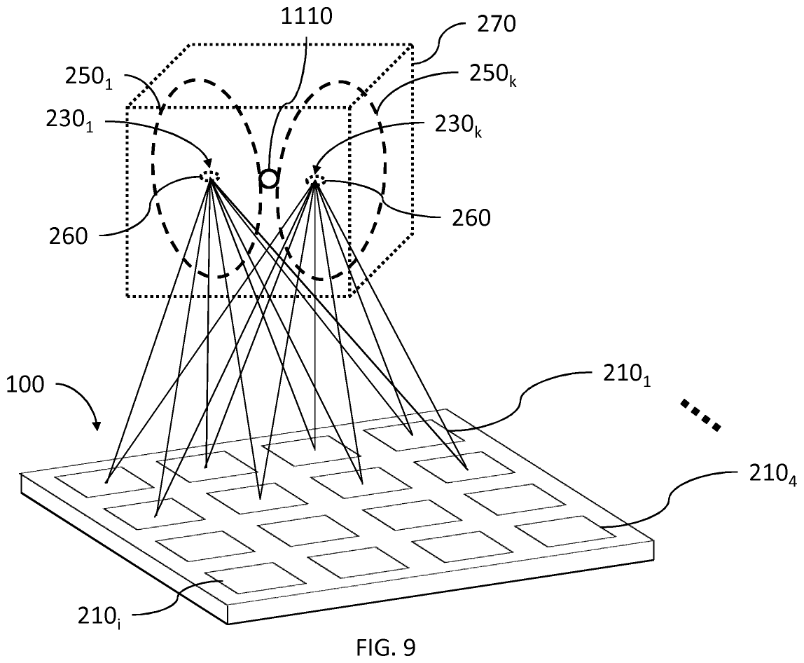

Embodiments disclosed herein may advantageously also be used in machine-machine interface (MMI) applications, wherein two dimensional arrays of MUT elements according to embodiments herein may be used for enabling contact-less levitation and manipulation of very small object being on a millimeter scale or even micro meter scale, by generating an acoustic-potential field of standing waves of correspondingly small wavelengths, such that one or more objects may be captured, withheld, and three dimensionally translated and/or rotated in a node created between two or more standing waves. A suitable size for objects to be manipulated is objects whose diameter is half of the wavelength of the ultrasonic emitted. Existing technology cannot achieve the high frequencies that are emitted by MUTs according to embodiments presented herein, and therefore cannot be used for manipulating correspondingly small objects. Also, objects with a diameter size of for example than 0.5 mm, which can be manipulated successfully by disclosed embodiments, are too small to be moved using mechanical tweezers or similar tools. Levitation and manipulation is sometimes popularly referred to as using “tractor beams”. Levitation and manipulation of very small objects may for example advantageously facilitate “pick-and-place” contact-less mounting of electronic components during a manufacturing process, precision robotics, and other applications wherein precision is key, and the object(s) to be manipulated is/are on a millimeter scale or even micro meter scale. Another non-limiting example embodiment is sorting or arranging of such small objects. A further non-limiting example embodiment is manipulation of one or more objects, wherein each object (e.g. the object 1110 described in connection with the embodiments of FIGS. 9 and 13b) comprises a small amount of fluid, i.e. a droplet. Manipulating objects in the form of small amounts of a fluid may be very useful in applications of highly controlled and/or sensitive environments where the fluid, should it not be manipulated, may cause problems. The manipulation may in such cases comprise changing the shape and/or the speed of the object. Applications where this is useful include, but are not limited to, “pick-and-place” contact-less mounting of electronic components during a manufacturing process, or precision robotics, wherein a droplet of ink, glue, solder etc. may be slowed down and/or manipulated into a suitable shape either when jetted from a nozzle or at or after coming into contact with a surface. An example of a system for generating an acoustic-potential field 270 of ultrasonic waves and enabling three dimensional acoustic levitation and manipulation of one or more objects using the acoustic-potential field 270 of ultrasonic waves is shown in FIGS. 13a and 13b, wherein FIG. 13b shows a top-view of the schematic illustration in FIG. 13a.

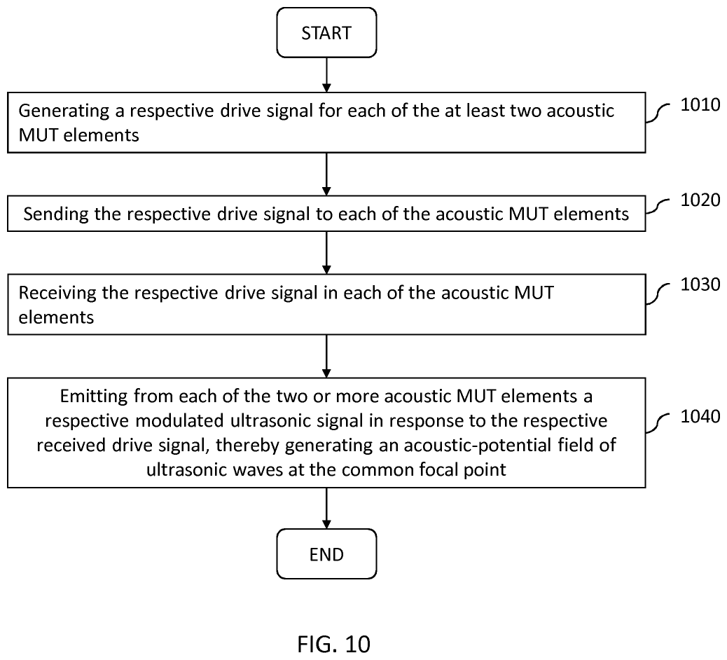

To enable three dimensional manipulation, four or more MUTs 200_{1 . . . j}, in the figures non-limitingly illustrated as four MUTs 200₁, 200₂, 200₃, 200₄, may be arranged on the inside of a three dimensional volume. In FIG. 10a the three-dimensional volume illustrated as a box 1100. For a person skilled in the art it is obvious that the embodiments presented herein may just as well be applied to volumes of other shapes, for example enclosed by spherical or at least partly curved surfaces. In one or more embodiment, the MUTs are arranged such that a first common focal line of ultrasound is generated, using at least one first MUT 200₁ and at least one second MUT 200₂ to provide a first beam 1120 of standing waves between the first and the second MUTs 200₁, 200₂, wherein the first MUT and the second MUT are opposite each other along a first axis A1; and such that a second common focal line of ultrasound is generated, using at least one third MUT 200₃ and at least one fourth MUT 200₄ to provide a second beam 1130 of standing waves between the third and the fourth MUTs 200₃, 200₄, wherein the third MUT and the fourth MUT are opposite each other along a second axis A2 perpendicular to the first axis A1. The MUTs are further arranged such that the first and second beams of standing waves intersect and provide, at the intersection of the standing waves, a node 1140 having a minimum sound pressure value at which an object 1110 of an appropriate size, with regard to the wavelength of the ultrasonic signal, and located in the common intersection point can be trapped or captured, withheld, and translated and/or rotated in three dimensions by modulation of the ultrasonic signals emitted from the MUTs 200₁, 200₂, 200₃, 200₄.

Additional pairs of MUTs 200 may also be used, arranged on the inside of the three dimensional volume so as to generate additional common focal lines of ultrasound and correspondingly additional beams of standing waves within the three dimensional volume. One or more additional MUT pairs may be arranged such that the corresponding one or more additional standing wave intersect at the common intersection point of the first and second beams of standing waves, thereby contributing to generating the node 1140, and improving the entrapment and enabled acoustic levitation and manipulation of the object 1110 by trapping it from several directions and at higher combined surrounding sound pressure. Thereby, wobbling of the object 1110 may be advantageously avoided. Alternatively, or in combination, two or more additional MUT pairs may be arranged such that the corresponding two or more additional standing wave intersect at one or more additional common intersection point, thereby generating an additional node or nodes configured to simultaneously entrap and acoustically levitate and manipulate an additional object or objects in the acoustic-potential field 270 of ultrasonic waves within the three dimensional volume 1100.

Another example of a system for generating an acoustic-potential field 270 of ultrasonic waves and enabling three dimensional acoustic levitation and manipulation of one or more objects using the acoustic-potential field 270 of ultrasonic waves is shown in FIG. 9.

In embodiments shown in FIG. 9, the respective phase shift to be applied to the modulated ultrasonic signal 220 of each of the two or more acoustic MUT elements 210 is configured to cause the ultrasound waves of the modulated ultrasonic signals 220 to be constructively combined at k common focal points 230_{1 . . . k} so as to generate an acoustic-potential field 270 comprising k acoustic lobes 250_{1 . . . k} around the respective k common focal points 230_{1 . . . k}. The system may be adapted to provide contact-less levitation or manipulation of one or more objects, in the figure exemplified by a single object 1110 for ease of illustration, by capturing the object/objects to be captured in a respective node at a sound pressure minima created between two or more acoustic lobes 250_{1 . . . k} of the generated acoustic-potential field. As described herein, the MUT technology, preferably MEMS technology, used in embodiments of the invention enables capturing, acoustic levitation and manipulation of very small objects, e.g. having a maximum cross-section width of less than 3 mm, preferably less than 1 mm, more preferably less than 0.5 mm. The system may be implemented as part of a machine-machine interface, MMI.

In some embodiments, instead of simultaneously generating the two or more acoustic lobes 250_{1 . . . k} of the acoustic-potential field, i.e. spatially dividing the emitted energy, the energy may be temporally divided at a very high rate between the two or more acoustic lobes 250_{1 . . . k} to generate e.g. two, three or four (or more, if suitable) differently positioned common focal points 230_{1 . . . k}. In other word, the emitted energy and the corresponding differently positioned common focal points 230_{1 . . . k} are rapidly multiplexed. In the manner described above, the position of the differently positioned common focal points 230_{1 . . . k} is controlled such that one or more sound pressure minima, wherein one or more object may be captured by the system, is created between pairs or groups of the differently positioned common focal points 230_{1 . . . k}. In such embodiments, the system may be adapted to provide contact-less levitation or manipulation of one or more objects, in the figure exemplified by a single object 1110 for ease of illustration, by capturing the object/objects to be captured in a respective node at a sound pressure minima created between an acoustic lobe 250 rapidly moving between two or more common focal points 230_{1 . . . k}, or a sound minima created between one or more acoustic lobe 250 being still in combination with one or more such rapidly moving acoustic lobe 250.

In all embodiments, the acoustic lobe or lobes 250 are controlled to generate at least one acoustic node at a corresponding sound pressure minimum. To achieve a multiplexing acoustic lobe 250, the controller 120 may be configured to, and the method according to any embodiment presented herein may comprise, controlling each of the two or more acoustic MUT elements 210 to sequentially emit a respective ultrasonic signal 220, comprising a plurality of ultrasonic waves, towards two or more common focal points 230_{1 . . . k}, wherein the location of the two or more common focal points 230_{1 . . . k} are selected such that at least one sound pressure minimum is created between the two or more acoustic lobes 250_{1 . . . k} which are generated at the respective two or more common focal points 230_{1 . . . k}. The rate at which the emitted energy and the corresponding differently positioned common focal points 230_{1 . . . k} are multiplexed is somewhere between 50 Hz and 5000 Hz, preferably between 100 Hz and 500 Hz, in a non-limiting example 200 Hz or close to 200 Hz. Since the acoustic lobes 250_{1 . . . k}, surrounding and creating between them the sound pressure minima, are generated in such rapid succession, the contactless capturing/trapping, levitation and/or manipulation of the object 1110 is enabled.

The advantage of dividing the emitted energy in time (multiplexing) is that less total energy is needed to achieve contactless capturing/trapping, levitation and/or manipulation of an object of a certain weight.

Division of emitted energy in time (multiplexing) instead of in space, or the combination of both, is also applicable to the embodiments described in connection with FIGS. 13a and 13b.

By the embodiments described herein, a dual trap, a quadruple trap, a vortex trap, or any other suitable formation may be generated for the purpose of capturing/trapping and levitating and/or manipulating one or more object.

In one or more embodiments, each of the one or more MUT in the system 100 may be a MUT 200 according to any of the embodiments presented in connection with FIG. 3.

The system 100 may further be adapted to perform the method according to any of the embodiments described in connection with FIG. 10.

It is to be appreciated that system 100 can be used in connection with implementing one or more systems or components shown and described in connection with other figures disclosed herein. It is noted that all or some aspects of system 100 can be comprised in larger systems such as servers, computing devices, smart phones, tablet computers, laptop computers, personal digital assistants, set top box, computer monitors, remote controllers, headphones, and the like. Further, it is noted that the embodiments can comprise additional components not shown for sake of brevity.

Furthermore, the controller 120 can control various circuitry, components, and the like, to facilitate proximity detection. For instance, the controller 120 can comprise a processing device (e.g., computer processor that controls generation of signals, modes of operation and the like.

Additionally, embodiments disclosed herein may be comprised in larger systems or apparatuses. For instance, aspects of this disclosure can be employed in smart televisions, smart phones or other cellular phones, tablet computers, laptop computers, desktop computers, monitors, digital recording devices, appliances, home electronics, gaming devices, automotive devices, personal electronic equipment, medical devices, industrial systems, robots, VR or AR or IR wearables, and various other devices or fields.

In one or more embodiment, the one or more MUTs 200 may piezoelectric micromachined ultrasonic transducers, p-MUTs, and the acoustic MUT elements 210 may be acoustic p-MUT elements. The piezoelectric material may comprise Lead zirconate titanate, PZT, or doped PZT. The piezoelectric material may comprise thin film PZT, or thin film doped PZT. In some embodiments, the piezoelectric material may comprise PNZT, or PZT doped with Niobium (Nb). In some embodiments, the PZT material may have a thickness of 0.5-5 μm, preferably 1-3 μm, more preferably around 2 μm.

In one or more embodiments, each acoustic MUT element 210 may comprise a membrane or a diaphragm. The membrane or diaphragm may further comprise silicon.

In other embodiments, the one or more MUTs 200 may be capacitive micromachined ultrasonic transducers, c-MUTs, and the acoustic MUT elements may be 210 acoustic c-MUT elements.

According to any of the embodiments presented herein, the array may comprise at least 400 acoustic MUT elements 210. As some non-limiting examples, the array may comprise 96×96 or 128×72 acoustic MUT elements 210.

The components of the system 100 may be configured to use any suitable communication technology known in the art for communicating with each other.

### MUT Architecture

In the present context, a MUT is to be understood as a micromachined device capable of receiving as well as emitting an ultrasonic pulse or signal in the form of ultrasonic waves. The transducer or MUT 200 comprises an array of acoustic MUT elements 210_{1 . . . i}, for example as shown in FIG. 3. In the example of FIG. 3, the array is illustrated with an x-y row-column coordinate system for ease of illustration, but other layouts are equally possible.

Below, a micromachined ultrasonic transducer (MUT) according to embodiments is described in more detail, with reference to the figures.

Turning to FIG. 3, there is shown a device, in the form of a MUT 200 for generating an acoustic-potential field of ultrasonic waves, the MUT 200 comprising an array of acoustic micromachined ultrasonic transducer, MUT, elements 210. Two or more of the acoustic MUT elements 210 in the array may each be configured to emit a respective modulated ultrasonic signal 220 comprising a plurality of ultrasound waves towards a common focal point 230, the plurality of ultrasound waves of the modulated ultrasonic signal 220 each comprising a carrier wave 221 being modulated according to a modulation signal 222. The two or more acoustic MUT elements 210 may further each be configured to emit the respective modulated ultrasonic signal 220 according to a respective predetermined phase shift, such that the respective modulated ultrasonic signal 220 of each of the two or more acoustic MUT elements 210 is phase shifted in relation to one another, so as to be constructively combined at the common focal point 230, thereby generating an acoustic-potential field 270 of ultrasonic waves having a focal volume 260 around the common focal point 230.

In some embodiments, the two or more acoustic MUT elements 210 are each configured to emit the respective modulated ultrasonic signal 220 at an electro-mechanical resonance frequency, of the MUT element 210, in the range of 20 kHz to 10 MHz, preferably in the range of 100 kHz to 500 kHz, more preferably in the range of 120 kHz to 350 kHz. The two or more acoustic MUT elements 210 may each be configured to emit the respective modulated ultrasonic signal 220 at a frequency configured to generate a focal volume 260 with a maximum cross-section diameter of less than 5 mm, preferably less than 3 mm, more preferably less than 1 mm.

In one or more embodiments, the two or more acoustic MUT elements 210 may each be arranged to emit the respective modulated ultrasonic signal 220 at a frequency within the human perceivable frequency spectrum, so as to produce human perceivable ultrasound feedback if sensed by a human sensory organ at the focal volume 260. In these embodiments, the two or more acoustic MUT elements 210 may be arranged to emit the respective modulated ultrasonic signal 220 at a frequency within a frequency spectrum configured to produce a human perceivable tactile stimuli if sensed by a human tactile sensory organ at the focal volume 260. Alternatively, or in combination with the above, each of the two or more acoustic MUT elements 210 may be arranged to emit the respective modulated ultrasonic signal 220 at a frequency within a frequency spectrum configured to produce a human perceivable auditory stimuli if sensed by a human auditory organ at the focal volume 260.

In one or more embodiment, the MUT 200 may be a piezoelectric micromachined ultrasonic transducer, p-MUT, and the acoustic MUT elements 210 acoustic p-MUT elements. The piezoelectric material may comprise Lead zirconate titanate, PZT, or doped PZT. The piezoelectric material may comprise thin film PZT, or thin film doped PZT. In some embodiments, the piezoelectric material may comprise PNZT, or PZT doped with Niobium (Nb). In some embodiments, the PZT material may ahve a thickness of 0.5-5 μm, preferably 1-3 μm, more preferably around 2 μm.

In one or more embodiments, each acoustic MUT element 210 comprises a membrane or a diaphragm. The membrane or diaphragm may further comprise silicon.

In other embodiments, the MUT 200 may be a capacitive micromachined ultrasonic transducer, c-MUT, and the acoustic MUT elements 210 acoustic c-MUT elements.

According to any of the embodiments presented herein, the array may comprise at least 400 acoustic MUT elements 210. As some non-limiting examples, the array may comprise 96×96 or 128×72 acoustic MUT elements 210.

Two or more acoustic MUT elements 210 may further be configured to receive a respective drive signal S_{Tx} from a controller 120, and generate the respective modulated ultrasonic signal 220 in response to the respective received drive signal S_{Tx}.

In some embodiments, wherein the MUT 200 is to be used not only for emitting ultrasonic signals, but also for recognizing whether there is an object in its vicinity, at least one of the acoustic MUT elements 210 of the MUT 200 may be configured to detect entry and exit of an object in a field of detection of the at least one acoustic MUT element 210; generate a detection signal S_{Rx} indicative of the detected entry and exit to a transducer controller 120; and send the detection signal S_{Rx} to a controller 120 being communicably coupled to the array of acoustic MUT elements 210 and being configured to identify a gesture based on the detection signal S_{Rx}. The at least one acoustic MUT element 210 may be configured to detect entry and exit of the object in a field of detection of the at least one acoustic MUT element 210 by generating an ultrasonic signal, or ultrasonic waves, for reflection off the object. In one or more embodiments, the at least one of the MUT element may be configured to detect entry and exit of the object in a field of detection of the at least one MUT element by emitting an ultrasonic signal, or un-modulated ultrasonic waves, for reflection off the object. FIG. 2 illustrates that the acoustic MUT elements may be configured to receive a reflected ultrasonic signal or waves 240_{1 . . . j} from an object located at the common focal point 230. The object may be a body part of a human, for example a finger, a palm of a hand, a wrist, a foot, part of the chest, the neck, or an ear. The at least one of the acoustic MUT elements configured to detect entry and exit of an object in a field of detection may be, but are not necessarily, part of the at least two MUT elements configured to generate the respective ultrasonic signal.

In the non-limiting examples of the figures, the MUT 200 is shown as having 8×8 (i=64) or 4×4 (i=16) MUT elements, respectively. It is evident to a person skilled in the art that any suitable number of MUT elements may be used in the array and that the representations in the figures are for illustrational purposes only.

The MUT technology enables use of an array of acoustic MUT elements for example having as few as 2×2, 4×4, 8×8 or 16×16 MUT elements, or as many as 96×96 or 128×72 MUT elements in the form of a two-dimensional array or other non-square array configuration including circular layouts and straggle p-MUT patterns, depending on the specific application. In some embodiments, the array comprises at least 400 MUT elements 210. In some embodiments, the array of the MUT 200 comprises 96×96 or 128×72 MUT elements 210. The latter embodiments with 96×96 or 128×72 MUT elements provide a MUT having almost 10 000 channels. This high resolution cannot be achieve using non miniaturized existing technology. Such a large resolution of the array in turn enables using a greater number of acoustic MUT elements 210 for emitting a respective modulated ultrasonic signal 220 towards each common focal point 230 compared to the existing technologies, which gives improved focus capabilities and a higher maximum energy or acoustic pressure at the focal volume 260, and/or emitting modulated ultrasonic signals 220 towards an increased number of common focal points 230, thereby enabling for example more realistic tactile stimulation feedback or auditory feedback, or simultaneous trapping and possible acoustic levitation and manipulation of numerous objects using a single system. In an “acoustic tweezers” system, as described in connection with FIG. 9, e.g., it may further be advantageous to use more than two, for example three, four, or possibly more, acoustic lobes 250 for levitation and/or manipulation of an object 1100 between the acoustic lobes. Thereby, wobbling of the captured object 1100 may be avoided or at least significantly reduced, and precision hence increased, especially in cases where the focal volume 260 may be larger than desired where a larger number of acoustic lobes 250 may be used for compensating for this.

Each of the two or more acoustic MUT elements may also be configured to generate and emit the respective ultrasonic signal according to a predetermined phase shift, such that the ultrasonic signal of each of the two or more acoustic MUT elements is phase shifted in relation to each other.

In one or more embodiments, the acoustic MUT elements 210_{1 . . . i} of the MUT 200 may be configured or controlled to generate a plurality of common focal points 230

The MUT 200 may be any suitable type of MUT. In one or more embodiments, the MUT 200 may be a piezoelectric MUT (p-MUT). The use of p-MUT devices is advantageous for generating high force and displacements, e.g. high sound pressure required to generate human perceivable feedback according to embodiments herein, because p-MUT devices require a low voltage and further transform electrical energy to mechanical energy in a very efficient manner. In other embodiments, the MUT 200 may be a capacitive MUT, (c-MUT).

The use of c-MUT devices is advantageous for the gesture recognition embodiments, because c-MUT devices transform mechanical energy into electrical energy in a very efficient manner. In one embodiment the MUT elements can be a combination of p- and c-MUT transducer principles.

It is noted that MUT elements 210 can comprise one or more sensing elements. Such sensing elements can include membranes, diaphragms, or other elements capable of sensing and/or generating ultrasonic waves. For instance, one or more membranes of MUT elements 210 can be excited to transmit an ultrasonic wave. In another aspect, a plurality of membranes of MUT elements 210 can receive ultrasonic waves that induce movement of the one or more membranes.

Method Embodiments

In an example embodiment of the method, firstly at least one 3D position defining a common focal point is determined, selected or retrieved. At least one MUT 200, comprising an array of acoustic MUT elements 210, is arranged to create an acoustic-potential field of ultrasonic waves, with the phases and amplitudes of each MUT element 210 calculated to achieve a high pressure at the focal point and a low pressure in surrounding areas. A frequency at which to modulate the feedback is then chosen in dependence on how the human perceivable feedback is intended to be perceived, e.g. felt or heard by a human. Then a modulation signal may be generated for modulating a carrier wave into a modulated ultrasonic signal 220, also in dependence on how the human perceivable feedback is intended to be perceived. The modulation signal may be emitted, by MUT elements 210, to generate the acoustic-potential field of ultrasonic waves.

FIG. 10 shows one or more embodiment of a method for controlling at least two acoustic micromachined ultrasonic transducer, MUT, elements in an array of acoustic MUT elements to emit a respective modulated ultrasonic signal comprising a plurality of ultrasound waves with a common focal point, the plurality of ultrasound waves of the modulated ultrasonic signal each comprising a carrier wave being modulated according to a modulation signal, so as to generate an acoustic-potential field of ultrasonic waves, the method comprising:

In step 1010: generating, by a controller, a respective drive signal for each of the at least two acoustic MUT elements.

The respective drive signal may be indicative of a frequency at which the acoustic MUT element is to be controlled to emit the respective modulated signal; the modulation signal for modulating the carrier signal to obtain a respective modulated ultrasonic signal; and a respective phase shift to be applied to the respective modulated ultrasonic signal, wherein the respective phase shift is configured such that the respective modulated ultrasonic signal of each of the two or more acoustic MUT elements is phase shifted in relation to one another, so as to be constructively combined at a common focal point.

The respective drive signal may further be indicative voltages and/or currents needed for the acoustic MUT elements to operate.

In step 1020: sending, by the controller, the respective drive signal to the acoustic MUT element.

In step 1030: receiving, in each of the two or more acoustic MUT elements, the respective drive signal.

In step 1040: emitting, by each of the two or more acoustic MUT elements, a respective modulated ultrasonic signal in response to the respective received drive signal.

Thereby an acoustic-potential field of ultrasonic waves is generated at the common focal point. The method steps may be performed repeatedly, so as to generate a continuous emission of modulated ultrasonic signals which may be altered over time.

The frequency at which the at least two acoustic MUT elements are to be controlled to emit the respective modulated signal is an electro-mechanical resonance frequency of the MUT element which may according to embodiments be in the range of 20 kHz to 10 MHz, preferably in the range of 100 kHz to 500 kHz, more preferably in the range of 120 kHz to 350 kHz. The electro-mechanical resonance frequency may alternatively be configured to generate a focal volume (260) with a maximum cross-section diameter of less than 5 mm, preferably less than 3 mm, more preferably less than 1 mm.

In one or more embodiments, emitting the respective modulated ultrasonic signal comprises emitting the modulation signal at a frequency within a frequency spectrum configured to produce a human perceivable sensory stimuli, so as to produce human perceivable sensory feedback if sensed by a human sensory organ at the common focal point. In some embodiments, emitting the respective modulated ultrasonic signal comprises emitting the modulation signal at a frequency within a frequency spectrum configured to produce a human perceivable tactile stimuli, so as to produce human perceivable tactile feedback if sensed by a human tactile sensory organ at the common focal point. In other embodiments, or in combination, emitting the respective modulated ultrasonic signal may comprise comprises emitting the modulation signal at a frequency within a frequency spectrum configured to produce a human perceivable auditory stimuli, so as to produce human perceivable auditory feedback if sensed by a human auditory sensory organ at the common focal point 230.

In some embodiments, the method further comprises receiving, by the controller, a detection signal from at least one acoustic MUT element in said array; identifying, by the controller, a gesture based on the received detection signal or signals; and generating, by the controller, the respective drive signal in response to identifying a gesture.

In one or more embodiments, the respective phase shift to be applied to the respective modulated ultrasonic signal of each of the two or more acoustic MUT elements may be configured to cause the ultrasound waves of the modulated ultrasonic signals to be constructively combined at the common focal point so as to generate an acoustic-potential field of standing ultrasonic waves at the common focal point. According to these embodiments, the method further comprises capturing/trapping an object with a maximum cross-section width of less than 3 mm, preferably less than 1 mm, more preferably less than 0.5 mm, in a node at a sound pressure minima created between two or more standing waves of the generated acoustic-potential field of standing waves.

In one or more alternative embodiments, the respective phase shift to be applied to the respective modulated ultrasonic signal of each of the two or more acoustic MUT elements is configured to cause the ultrasound waves of the modulated ultrasonic signals to be constructively combined at two or more common focal points so as to generate an acoustic-potential field comprising respective acoustic lobes around the respective two or more common focal points. According to these embodiments, the method further comprises capturing/trapping one or more objects in a respective one or more node at a sound pressure minima created between two or more acoustic lobes of the generated acoustic-potential field.

In any of the embodiments for capturing/trapping an object, the method may further comprise contactlessly/in air translating or rotating the captured object, by further modulating the emitted modulated ultrasonic signals.

Further Applications

The non-contact ultrasonic feedback system 100 may advantageously be adapted for providing contactless human perceivable feedback in a human machine interface (HMI).

In a non-limiting example, the non-contact ultrasonic feedback system 100 may be adapted for providing contactless human perceivable feedback to a user via an HMI in a cockpit of a motorized vehicle, wherein the vehicle may be a car, a truck, a bus, an airplane or a train, and the user may be the driver, pilot, co-driver, co-pilot or passenger of the motorized vehicle.

In another non-limiting example, the non-contact ultrasonic feedback system 100 may be adapted for providing contactless human perceivable feedback to a user via an HMI in a public setting, such as e.g. a hospital setting, where many people interact with the HMI and it is desirable to reduce the risk of contamination via surfaces.

In yet another non-limiting example, the non-contact ultrasonic feedback system 100 may be adapted for providing contactless human perceivable feedback to a user via an HMI in a robotics application.

MUTs (200) according to embodiments herein may also advantageously be used for other applications than providing human perceivable feedback in a HMI, for example in machine-machine interfaces (MMI).

Compared to existing technology, examples of which may be found in the patent publications US20130047728A1 and US20170004819A1, MUTs according to embodiments presented herein enable three dimensional manipulations of much smaller objects. This is due to the fact that MUTs according to embodiments described herein enable generation of ultrasonic signals 220 at an electro-mechanical resonance frequency in the range of 20 kHz to 10 MHz, preferably in the range of 100 kHz to 500 kHz, most preferably in the range of 120 kHz to 350 kHz. By generating ultrasonic signals having an electro-mechanical resonance frequency over 100 kHz, for instance, the wavelength of the signal will be less than 1 mm, whereby objects smaller than 0.5 mm can be successfully manipulated.

Further applications or technological areas wherein embodiments presented herein may advantageously be implemented include, but not limited to:
Digital electronic braille for blind people
Gaming: Augmentation (AR) or full Immersive virtual reality (IR) gesture-controlled gaming
Automotive: in-air safety application for feedback and control including steering of infotainment systems and dashboard functions. Digitally controlled knobs can e.g. be personalized by virtual 3D Hologram with HMI feedback of ultrasonic waves for tactile and/or audio feedback.
Location-based entertainment: 4D and 5D cinema and studios to add directional stimuli of tactile and audio sense on top of visual 3D impression and surround sound.
AR/VR: Immersive experiences and intuitive interaction with virtual objects.
Infotainment/education and computing: An extra dimension to 3D imaging and interaction with virtual objects or real object, for example at a museum/gallery where digital surface texture of old and sensitive objects can give improved stimuli to the visitor.
Smart home: Invisible, non-contact virtual buttons, slide bars and responsive controls that can be digitally personalized
Industrial and medical: Touch-less HMI to improve health and

Further Embodiments

All of the process steps, as well as any sub-sequence of steps, described with reference to FIG. 10 above may be controlled by means of a programmed data processor. Moreover, although the embodiments of the invention described above with reference to the drawings comprise a data processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

In one or more embodiments, there may be provided a computer program loadable into a memory communicatively connected or coupled to at least one data processor, e.g. the controller 120 or the external processor 130, comprising software for executing the method according any of the embodiments herein when the program is run on the at least one controller 120 or external processor 130

In one or more further embodiment, there may be provided a processor-readable medium, having a program recorded thereon, where the program is to make at least one data processor, e.g. the controller 120 or the external processor 130, execute the method according to of any of the embodiments herein when the program is loaded into the at least one data processor.

The invention is not restricted to the described embodiments in the figures, but may be varied freely within the scope of the claims.

1-54. (canceled)

55. A system (100) for generating an acoustic-potential field (270) of ultrasonic waves, the system (100) comprising:
an array of acoustic micromachined ultrasonic transducer, MUT, elements (210), the array of acoustic MUT elements (210) being comprised in one or more micromachined ultrasonic transducer, MUT; and
a controller (120) being communicably connected to two or more of said acoustic MUT elements (210) in said array,
wherein the controller (120) is configured to control each of the two or more acoustic MUT elements (210) to emit a modulated ultrasonic signal (220) comprising a plurality of ultrasound waves towards at least one common focal point (230), by:
generating a respective drive signal (STx) indicative of:
the frequency at which the at least two acoustic MUT elements (210) are to be controlled to emit the respective modulated ultrasonic signal (220), and
a respective phase shift and amplitude to be applied to the modulated ultrasonic signal (220) of each of the two or more acoustic MUT elements (210), configured to cause the ultrasound waves of the modulated ultrasonic signals (220) to be constructively combined at the at least one common focal point (230); and
sending the respective drive signal (STx) to the acoustic MUT element (210),
wherein the two or more acoustic MUT elements (210) of the array to which the respective drive signals (STx) are sent is each configured to:
receive the respective drive signal (STx); and
emit a respective modulated ultrasonic signal (220) in response to the respective received drive signal (STx), thereby generating an acoustic-potential field (270) of ultrasonic waves having a respective focal volume (260) around the at least one common focal point (230).

56. The system (100) of claim 55, wherein the plurality of ultrasound waves of the modulated ultrasonic signal (220) each comprise a carrier wave (221) being modulated according to a modulation signal (222), wherein the respective drive signal (STx) is further indicative of the modulation signal (222).

57. The system (100) of claim 55, wherein the two or more acoustic MUT elements (210) are each configured to emit the respective modulated ultrasonic signal (220) at an electro-mechanical resonance frequency of the MUT element (210) in the range of 20 kHz to 10 MHz, preferably in the range of 100 kHz to 500 kHz, more preferably in the range of 120 kHz to 350 kHz.

58. The system (100) of claim 55, wherein the at least one MUT (200) and the controller (120) are fixedly arranged on or embedded in a substrate (110).

59. The system (100) of claim 55 being adapted for providing non-contact human perceivable feedback to a user in a human machine interface (HMI).

60. The system (100) of claim 55,
wherein the respective phase shift to be applied to the modulated ultrasonic signal (220) of each of the two or more acoustic MUT elements (210) is configured to cause the ultrasound waves of the modulated ultrasonic signals (220) to be constructively combined at the common focal point (230) so as to generate an acoustic-potential field of standing ultrasonic waves at the common focal point (230),
wherein the system is adapted to provide contact-less levitation or manipulation of an object in a machine-machine interface, MMI, by capturing the object to be levitated or manipulated in a node at a sound pressure minima created between two or more standing waves of the generated acoustic-potential field of standing waves,
wherein the object to be levitated or manipulated has a maximum cross-section width of less than 3 mm, preferably less than 1 mm, more preferably less than 0.5 mm.

61. The system (100) of claim 55, wherein the controller (120) is configured to generate the respective drive signal (STx) to be indicative of a respective phase shift and amplitude to be applied to the modulated ultrasonic signal (220) of each of the two or more acoustic MUT elements (210) configured to cause the ultrasound waves of the modulated ultrasonic signals (220) of the two or more acoustic MUT elements (210) to be constructively combined at two or more common focal points (2301 . . . k), thereby controlling each of the two or more acoustic MUT elements (210) to, when emitting the respective modulated ultrasonic signal (220) in response to the respective received drive signal (STx), generate an acoustic-potential field (270) of ultrasonic waves comprising respective two or more acoustic lobes (2501 . . . k) around the two or more common focal points (2301 . . . k).

62. The system (100) of claim 61, wherein the phases and amplitudes of the acoustic MUT elements (210) in the array of acoustic MUT elements (210) are selected such that when the ultrasound waves of the modulated ultrasonic signals (220) are constructively combined at the two or more common focal points (2301 . . . k), high pressure is achieved at the two or more common focal points (2301 . . . k) and low pressure is achieved in surrounding areas.

63. A micromachined ultrasonic transducer, MUT, (200) for generating an acoustic-potential field of ultrasonic waves, the MUT (200) comprising:
an array of acoustic micromachined ultrasonic transducer, MUT, elements (210),
two or more of the acoustic MUT elements (210) in the array each being configured to emit a respective modulated ultrasonic signal (220) comprising a plurality of ultrasound waves towards at least one common focal point (230),
each of the two or more acoustic MUT elements (210) being configured to emit the respective modulated ultrasonic signal (220) according to a respective predetermined phase shift and amplitude, such that the respective modulated ultrasonic signal (220) of each of the two or more acoustic MUT elements (210) is phase shifted in relation to one another, so as to be constructively combined at the at least one common focal point (230), thereby generating an acoustic-potential field (270) of ultrasonic waves having a respective focal volume (260) around each of the at least one common focal point (230).

64. The MUT (200) of claim 63, wherein the MUT (200) is a piezoelectric micromachined ultrasonic transducer, p-MUT, and the acoustic MUT elements (210) are acoustic p-MUT elements.

65. A method for controlling at least two acoustic micromachined ultrasonic transducer, MUT, elements (210) in an array of acoustic MUT elements (210) to emit a respective modulated ultrasonic signal (220) comprising a plurality of ultrasound waves with a common focal point (230), so as to generate an acoustic-potential field (270) of ultrasonic waves, the method comprising:
for each of the at least two acoustic MUT elements (210):
generating, by a controller (120), a respective drive signal (STx) indicative of:
(a) a frequency at which the acoustic MUT element (210) is to be controlled to emit the respective modulated ultrasonic signal (220); and
(b) a respective phase shift and amplitude to be applied to the respective modulated ultrasonic signal (220), wherein the respective phase shift is configured such that the respective modulated ultrasonic signal (220) of each of the two or more acoustic MUT elements (210) is phase shifted in relation to one another, so as to be constructively combined at a common focal point (230);
sending, by the controller (120), the respective drive signal (STx) to the acoustic MUT element (210),
receiving, in each of the two or more acoustic MUT elements (210), the respective drive signal (STx); and
emitting, by each of the two or more acoustic MUT elements (210), a respective modulated ultrasonic signal (220) in response to the respective received drive signal (STx), thereby generating an acoustic-potential field (270) of ultrasonic waves at the common focal point (230).

66. The method of claim 65, wherein the plurality of ultrasound waves of the modulated ultrasonic signal (220) each comprise a carrier wave (221) being modulated according to a modulation signal (222) and wherein generating, by the controller (120), the respective drive signal (STx) comprises generating the respective drive signal (STx) to further be indicative of the respective modulation signal (222), and wherein the frequency at which the at least two acoustic MUT elements are to be controlled to emit the respective modulated signal is an electro-mechanical resonance frequency of the MUT element, wherein the electro-mechanical resonance frequency is in the range of 20 kHz to 10 MHz, preferably in the range of 100 kHz to 500 kHz, more preferably in the range of 120 kHz to 350 kHz.

67. The method of claim 65, wherein the respective phase shift to be applied to the respective modulated ultrasonic signal of each of the two or more acoustic MUT elements is configured to cause the ultrasound waves of the modulated ultrasonic signals to be constructively combined at the common focal point so as to generate an acoustic-potential field of standing ultrasonic waves at the common focal point, wherein the method further comprises:
capturing an object with a maximum cross-section width of less than 3 mm, preferably less than 1 mm, more preferably less than 0.5 mm, in a node at a sound pressure minima created between two or more standing waves of the generated acoustic-potential field of standing waves.

68. The method of claim 66, comprising selecting the phases and amplitudes of the acoustic MUT elements (210) in the array of acoustic MUT elements (210) such that when the ultrasound waves of the modulated ultrasonic signals (220) are constructively combined at the two or more common focal points (2301 . . . k), high pressure is achieved at the two or more common focal points (2301 . . . k) and low pressure is achieved in surrounding areas.

69. The method of claim 66, wherein the respective phase shift to be applied to the respective modulated ultrasonic signal (220) of each of the two or more acoustic MUT elements (210) is configured to cause the ultrasound waves of the modulated ultrasonic signals (220) to be constructively combined at two or more common focal points (2301 . . . k) so as to generate an acoustic-potential field (270) comprising respective acoustic lobes (2501 . . . k) around the respective two or more common focal points (2301 . . . k), the method further comprising:
capturing one or more object in a respective one or more node at a sound pressure minima created between two or more acoustic lobes (2501 . . . k) of the generated acoustic-potential field (270).
